(19) United States
(12) Patent Application Publication
(10) Pub. No.: US 2016/0243739 A1
(43) Pub. Date: Aug. 25, 2016

(54) Injection-Molding Tool with Integrated Air Jets

(71) Applicant: Ford Motor Company, Dearborn, MI (US)

(72) Inventor: Junko Pauken, Canton, MI (US)

(21) Appl. No.: 14/626,981

(22) Filed: Feb. 20, 2015

(51) Int. Cl. B29C 45/17

(52) U.S. Cl. CPC B29C 45/1753; B29L 2031/00

(57) ABSTRACT

An injection-molding tool includes a first die having a first surface, and a second die having a second surface. The first and second surfaces cooperate to define a part cavity when the tool is closed. The tool also includes at least one jet disposed on the first surface for blowing gas toward the second surface to remove debris from the second surface.

### TECHNICAL FIELD

The present disclosure relates to injection-molding tools.

### BACKGROUND

Automotive components may be produced by injection-molding processes. In conventional injection molding, a resin material is injected into a part cavity defined by a plurality of dies. After molding, the part typically under goes secondary processing, such as painting, film, or plating.

In mold-in-color plastic-injection molding a class “A” finished surface is created during the injection-molding process and secondary processing is not preformed. Because there is no secondary processing, any defects formed during molding of the component cannot be fixed and the component must be scrapped.

### SUMMARY

According to one aspect of this disclosure, an injection-molding tool includes a first die having a first surface, and a second die having a second surface. The first and second surfaces cooperate to define a part cavity when the tool is closed. The tool also includes at least one jet disposed on the first surface for blowing gas toward the second surface to remove debris from the second surface. The injection-molding tool may include ejector pins extendable out of the first surface for ejecting and trimming an injection-molded part. The at least one jet may be activated subsequent to the actuation of the ejector pins to remove any debris created during trimming of the part.

According to another aspect of this disclosure, a method is disclosed for operating an injection-molding tool. The tool includes first and second dies that each have a tool face. At least one jet is disposed on one of the first and second dies. The method includes the steps of closing the dies to form a part cavity defined by the tool faces, and injecting resin into the cavity. The method further includes cooling the part, opening the cavity allowing removal of the part, and blowing compressed gas through the jets to remove debris from the tool faces. The method may also include the steps of ejecting the part and trimming excess material from the part with one or more ejector pins. The blowing step may be performed after the trimming step.

According to yet another aspect of this disclosure, an injection-molding tool includes a mold cavity having a first tool surface, and a mold core having a second tool surface. The first and second tool surfaces cooperate to at least partially define a part cavity when the tool is closed. A cooling plate is disposed adjacent to the mold cavity on a side opposite the mold core. The cooling plate includes coolant channels. At least one jet is disposed on the second tool surface for blowing gas toward the first tool surface to remove debris from the second surface. The mold core may include ejector pins extendable out of the second tool surface for ejecting a part and trimming runners from the part.

### BRIEF DESCRIPTION OF THE DRAWINGS

FIG. 1 is a schematic cross-sectional view of an injection-molding tool with first and second dies closed and with a cooling plate in a disengaged position.

FIG. 2 is a schematic cross-sectional view of the injection-molding tool with the first and second dies closed and with the cooling plate in an engaged position.

FIG. 3 is a schematic cross-sectional view of the injection-molding tool with the first and second dies open.

FIG. 4 is a flow chart illustrating steps for molding a part using the injection-molding tool from FIGS. 1 to 3.

FIG. 5 is a zoomed-in perspective view of the injection-molding tool illustrating an ejector pin and a runner of the part.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

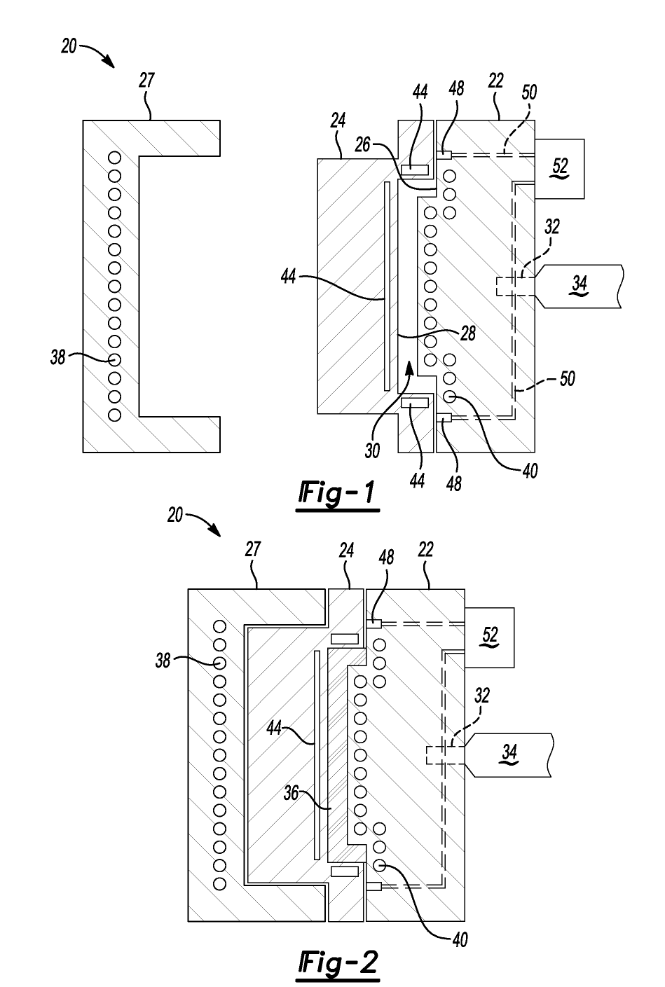

Referring to FIGS. 1, 2, and 3, an injection-molding tool 20 is illustrated. The injection-molding tool 20 may be configured to create a part having a finished surface that does not require secondary operations, such as painting. The tool 20 is schematically illustrated and some ancillary equipment that may be required to completely form a part through an injection-molding process are omitted.

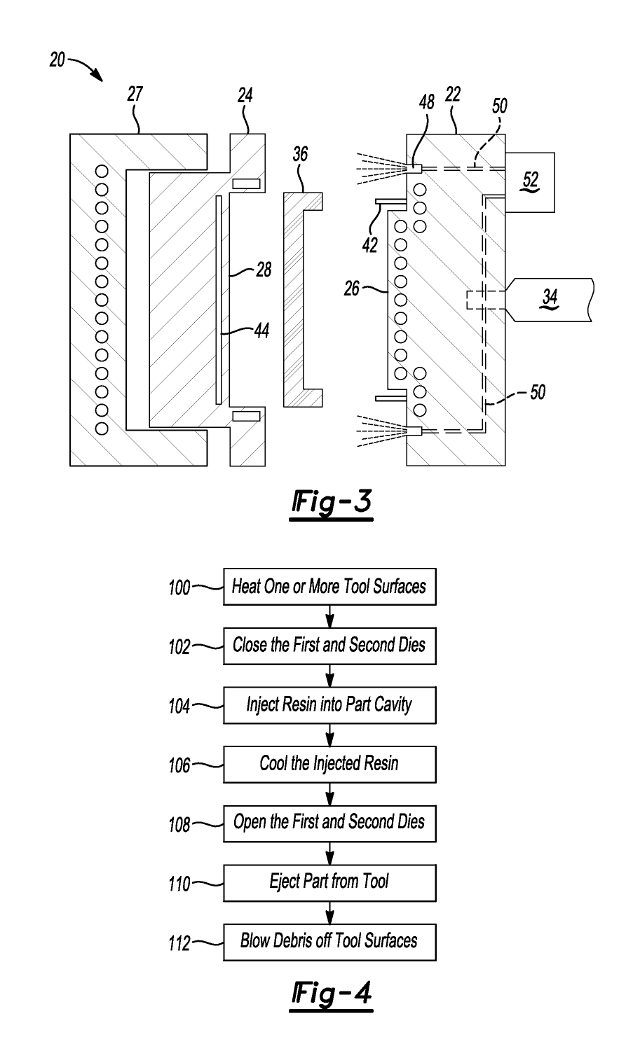

The tool 20 includes a first die (or mold core) 22 and a second die (or mold cavity) 24. The first die 22 includes a tool surface 26 and the second die 24 includes a tool surface 28. The first and second dies 22, 24 are movable relative to each other between an open position (illustrated in FIG. 3) and a closed position (illustrated in FIGS. 1 and 2). When in the closed position, the tool surfaces 26 and 28 cooperate to at least partially define a part cavity 30. The first die 22 may define an injector port 32 providing access into the part cavity 30. An injector 34 injects a resin material into the injector port 32 and subsequently into the part cavity 30 via subgates. The resin material is heated to a predefined temperature by a heater (not shown) prior to injection. The injected resin material is then allowed cool into a hardened part 36. The tool 20 may include cooling devices to speed up the hardening time of the resin. For example, the tool 20 includes a cooling plate 27 disposed against the second die 24. The cooling plate 27 defines coolant channels 38 configured to circulate coolant through the plate 27. The first die 22 may also include cooling channels 40. In some embodiments, the second die 24 and the cooling plate 27 are combined into a single part. After the part has hardened, the first and second dies open and the part 36 is ejected via one or more ejector pins 42.

The tool 20 may be configured to produce mold-in-color parts. Mold-in-color parts exit the injection-molding tool with a finished surface and do not require any secondary operations—such as painting or plating. Because mold-in-color parts do not undergo secondary operations, any defects created on the class-A surface during injection molding cannot be fixed and the defective part must be scrapped. To reduce part defects, the tool 20 may include heating elements 44. The heating elements 44 may be disposed in the second die 24 adjacent to tool surface 26, which is the tool surface that forms the class-A surface of the part. The heating elements 44 maintain the tool surface 26 at a temperature near or above the glass transition temperature of the injected resin to prevent premature cooling of the resin as it enters the part cavity 30. This helps to reduce defects formed during injection molding of the part 36. The heating elements 44 may be electric heating elements, or may be heated by other methods, such as steam or gas.

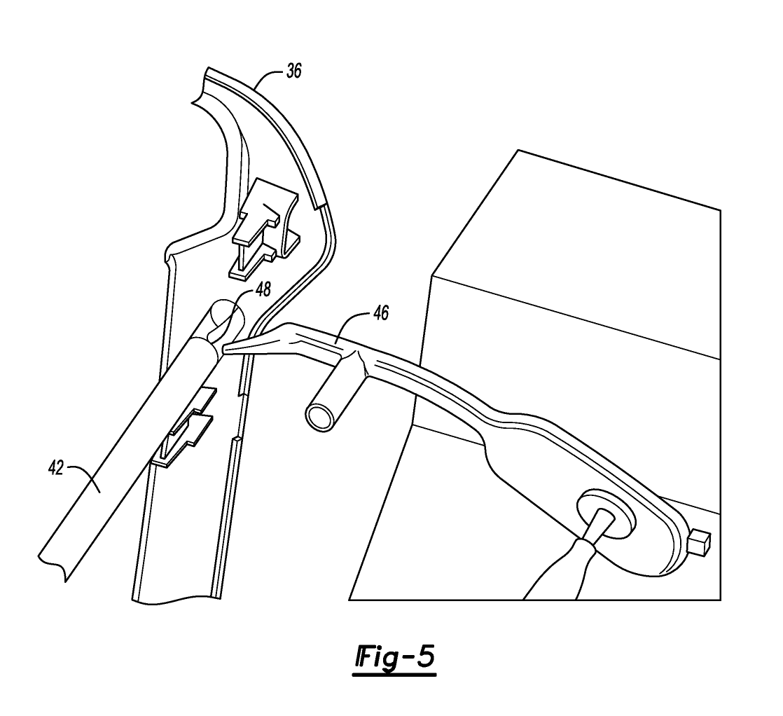

Referring to FIG. 4, a flow chart illustrating one example of an injection-molding process is shown with reference to FIGS. 1 through 3. At step 100 the first and second dies 22, 24 are in the open position and the heating elements 44 are activated to heat tool surface 26. The second die 24 is heated in isolation to reduce the size of the heat sink and shorten heating times and reduce the energy required. After the second die 24 is heated to a desired temperature, the dies 22, 24 are closed forming the part cavity 30 at step 102. At step 104 resin is injected into the part cavity 30. At step 106 the cooling plate 27 is closed around the second die 24 to cool the resin into a hardened part 36. At the same time, coolant may be circulated through coolant channels 40 of the first die 22 to further facilitate hardening of the resin. The cooling plate 27 is retracted from the second die 24, and the first and second dies 22, 24 are opened at step 108 after the resin has hardened forming a part 36.

At step 110 the part 36 is ejected from the tool 20 by one or more ejector pins 42. As best seen in FIG. 5, at least one of the ejector pins 42 is arranged to eject the part 36 and simultaneously sheer the runner 46 from the part 36 during ejection. Each of the ejector pins 42 may include a cutting surface 48 engageable with one of the runners 46 to sheer the runner 46 from the part 36. Sheering the runner can create debris that settle onto the tool surfaces 26, 28. If any of the debris remain on the tool surface 28 during subsequent injection molding, the class-A surface of the part 36 can be blemished. If the part 36 is a mold-in-color part, the blemish cannot be fixed, and the part must be scrapped.

The tool 20 includes gas jets 48 for blowing the debris off of one or more of the tool surfaces 26, 28 at step 112. The gas jets 48 are configured to blow compressed gas, such as air, nitrogen, oxygen or any other type of gas. The gas jets 48 may be disposed on the tool surface 26 of the first die 22. The gas jets 48 may be aimed to blow gas at tool surface 28. Each of the gas jets 48 includes a supply line 50 for receiving compressed gas. The supply lines 50 link the jets 48 in fluid flow communication with a compressor 52. The compressor 52 may include a gas storage tank for holding compressed gas. The compressor 52 may be disposed on the first die 22 or may be separate from the tool 20.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An injection-molding tool comprising:
a first die having a first surface;
a second die having a second surface cooperating with the first surface to define a part cavity when the tool is closed; and
at least one jet disposed on the first surface for blowing gas toward the second surface to remove debris from the second surface.

2. The injection-molding tool of claim 1 wherein the first die defines a resin inlet connected with the part cavity.

3. The injection-molding tool of claim 2 further comprising an injector connected with the resin inlet, and configured to inject resin into the part cavity to create an injection molded part having runners.

4. The injection-molding tool of claim 3 wherein the first die further includes ejector pins extendable out of the first surface for ejecting the part and trimming the runners from the part.

5. The injection-molding tool of claim 4 wherein each of the ejector pins includes a cutting surface for trimming the runners.

6. The injection-molding tool of claim 4 wherein trimming the runners creates at least some of the debris.

7. The injection-molding tool of claim 1 further comprising heating elements disposed in the second die.

8. The injection-molding tool of claim 1 further comprising a cooling plate engagable with an outer surface of the second die, and defining coolant channels therein.

9. The injection-molding tool of claim 1 further comprising a compressor in fluid flow communication with the at least one jet.

10. A method of operating an injection-molding tool including first and second dies that each have a tool face, wherein at least one of the dies has jets, the method comprising:
closing the dies to form a part cavity defined by the tool faces;
injecting resin into the cavity;
cooling the resin to form a part;
opening the cavity; and
blowing compressed gas through the jets to remove debris from the tool faces.

11. The method of claim 10 further comprising the steps of:
ejecting the part; and
trimming excess material from the part.

12. The method of claim 11 wherein the blowing step is preformed after the trimming step.

13. The method of claim 10 wherein the second die further includes heating elements and the method further comprising the step of heating the tool face with the heating elements.

14. The method of claim 10 wherein the blowing step is preformed when the dies are at least partially closed.

15. The method of claim 10 further comprising the step of supplying compressed gas to the jets from a gas storage tank.

16. An injection-molding tool comprising:
a mold cavity having a first tool surface;
a mold core having a second tool surface cooperating with the first tool surface to at least partially define a part cavity when the tool is closed;
a cooling plate including coolant channels, and disposed adjacent to the mold cavity on a side opposite the mold core; and
at least one jet disposed on the second tool surface for blowing gas toward the first tool surface to remove debris from the second surface.

17. The injection-molding tool of claim 16 wherein the mold cavity includes heating elements for heating the first tool surface and wherein the first tool surface is configured to produce mold-in-color parts.

18. The injection-molding tool of claim 16 wherein the mold core further includes ejector pins extendable out of the second tool surface for ejecting a part and trimming runners from the part.

19. The injection-molding tool of claim 18 wherein at least some of the debris are particles of the runners created during the trimming of the runners.

20. The injection-molding tool of claim 19 wherein the air jets are activated after the ejector pins trim the runners.
